(19) United States
(12) Patent Application Publication
(10) Pub. No.: US 2013/0345989 A1
(43) Pub. Date: Dec. 26, 2013

(54) METHOD AND DEVICE FOR COUNTING PARTICLES IN LIQUID

(71) Applicant: HORIBA, Ltd., Kyoto-shi (JP)

(72) Inventor: Kazuhiro Miyamura, Kyoto-shi (JP)

(21) Appl. No.: 13/926,946

(22) Filed: Jun. 25, 2013

(30) Foreign Application Priority Data
Jun. 26, 2012 (JP) 2012-143371

(51) Int. Cl. G01N 27/06; G06F 19/10

(52) U.S. Cl. CPC G01N 27/06; G06F 19/10
USPC 702/21; 324/71.4

(57) ABSTRACT

For a blood cell measuring part replaceably formed as a cartridge, a threshold value for determining particles is adjusted utilizing a specific parameter that observably varies according to the cross-sectional area of the aperture for use. In a first embodiment, the volume of the smallest frequency in the obtained volume-frequency distribution is used as a threshold value K1 specific to the cartridge for use. In second to fifth embodiments, the threshold values of pulse voltage height or pulse voltage width is adjusted based on the ratio of the voltage between electrodes specific to the cartridge or the ratio of the flow velocity of the sample liquid, every time the cartridge for use is replaced.

### CROSS-REFERENCE TO RELATED APPLICATION(S)

This application is based on a patent application No. 2012-143371 filed on Jun. 26, 2012, the contents of which are incorporated in full herein by this reference.

### FIELD OF THE INVENTION

The present invention relates to a technique for counting particles such as blood cells and the like in a liquid, based on an electrical resistance method.

### BACKGROUND OF THE INVENTION

As a method for counting blood cells such as red blood cells, white blood cells, blood platelets and the like in the blood, an electrical resistance method (also referred to as an impedance method) which is performed using an aperture and a pair of electrodes provided in a flow channel for a sample liquid is known and a device therefor is also known (e.g., patent documents JP-A-2011-227100, JP-A-2011-180117, Japanese Patent No. 3869810 (JP-A-2004-257768), Japanese Patent No. 3911259 (JP-A-2005-062137), Japanese Patent No. 3909050 (JP-A-2005-91098), etc.).

FIGS. 8(a) and 8(b) are schematic views showing the basic principle of and the constitution of a device for the electrical resistance method.

As shown in FIG. 8(a), in a typical electrical resistance method, a sample liquid containing a predetermined amount of blood specimen dispersed in a diluent is introduced into a flow channel 100 containing an aperture (small opening) 200 like an orifice, which has a reduced cross-sectional area and is provided in the mid-flow, and a pair of electrodes 300, 310 provided across the aperture 200 in the direction of flow (in JP-A-2011-180117, the flow channel at the downstream of the aperture is branched into two according to its unique configuration and, in Japanese Patent No. 3911259 (JP-A-2005-062137), a pair of electrodes are provided downstream of the aperture according to its unique configuration; however, the techniques of the both documents are the same in the following principle for determining the size of particles).

When one blood cell X10 passes through the aperture 200, the electrical resistance or impedance between the electrodes varies in a pulse-shape. Thus, when a voltage is being applied to the pair of electrodes 300, 310 from a constant-current power supply 400, the applied voltage also varies in a pulse-shape (a pulse voltage), as shown in FIG. 8(b), according to the above-mentioned impedance variation. By enumerating (counting) the number of pulse voltages by, for example, a computing part 500 or the like connected to the constant-current power supply, it is possible to know the number of particles.

Also, since the pulse voltage height Vp on passage of a particle through the aperture is proportional to the size of the particle, a large or small volume of the particle can be determined from the pulse voltage height.

Alternatively, the pulse voltage width Vw on passage of a particle through the aperture varies according to the speed of passage of the particle. When the flow velocity is constant, the pulse voltage width increases in proportion to the size of the particle, and therefore, the large or small volume of the particle can also be determined to some extent from the pulse voltage width Vw.

Therefore, particle counting according to the electrical resistance method affords not only a particle count but also a volume-frequency distribution showing particles with what volume were present at what frequency in a sample liquid.

FIG. 9(a) is a graph showing one example of a typical volume-frequency distribution of white blood cells in a certain sample liquid, which was obtained by the above-mentioned electrical resistance method, wherein the abscissa shows the volume (unit fL: femtoliter) corresponding to the pulse voltage height of each particle and the ordinate shows frequency (counted number). The graph shows the volume-frequency distribution in the range of 0 to 140 fL.

As is clear from the graph of FIG. 9(a), the line of the graph of the volume-frequency distribution of white blood cells in the volume range of 0 to 140 fL shows a frequent mountain peak between about 40 and 100 fL, a frequent valley between 20 and 40 fL, and a precipitous increase in the particle frequency at below 20 fL. The substance of the fine particle below 20 fL is mainly a fine bubble produced by electrolysis with current between the electrodes, a piece of a cell membrane produced by hemolysis (called ruptured red blood cell) or a blood platelet, which should be removed as noise or noise particles from white blood cell counting.

Conventionally, therefore, blood cells and noise particles are determined by setting a threshold value Ks, fixedly, to the volume of particles, or the pulse voltage height or pulse voltage width corresponding thereto, which is shown by the alternate long and short dash line between 20 and 40 fL, counting the particles with a volume not less than the threshold value as blood cells, and removing the particles with a volume smaller than the threshold value as noise particles.

In conventionally available blood cell counting devices, the manufacturers adjust the threshold value Ks of pulse voltage height and the like of each device by reference to the standard threshold values of their own and the data of volume-frequency distribution. The standard threshold value once adjusted is continuously used as an unchangeable constant.

However, the present inventors have studied in detail the state of particle counting by conventional blood cell counting devices described above, and found the following problems.

The problems are those associated with the technical development of blood cell counting device and are counting errors and a high cost of cartridge, which result from fabrication of a blood cell measuring part (basic structural part for the electrical resistance method constituted by a flow channel, an aperture formed in the flow channel, and a pair of electrodes provided across the aperture) in the form of a disposable, replaceable cartridge (hereinafter to be simply referred to as a “cartridge”) as shown in JP-A-2011-227100, JP-A-2011-180117 and Japanese Patent No. 3869810 (JP-A-2004-257768).

In prior blood cell counting devices containing a blood cell measuring part in a replaceable cartridge, the same blood cell measuring part was washed and repeatedly used. Therefore, a device after final adjustment of the threshold value as described above does not, in principle, show different sensitivity. However, in a device having a blood cell measuring part in a cartridge, since a set of a flow channel, an aperture and electrodes is replaced for each measurement, the sensitivity of pulse voltage height and pulse voltage width to the particles varies every time the cartridge is replaced.

FIG. 9(b) is a graph in which volume-frequency distributions of white blood cell, which were obtained by exchanging many cartridges for the same sample liquid, are superpositioned in a single graph. As is clear from the graph, since the sensitivity changes for each cartridge, the volume-frequency distributions of white blood cells varies by shifting in the higher and smaller directions of the volume.

According to the study of the present inventor, it has been found that the variation in the sensitivity as described above is greatly affected by, in particular, the cross-sectional area of apertures (area of cross-section taken perpendicularly to the passage direction of aperture) and, even if apertures have been processed with high dimensional precision as replacement parts, the variation in the aperture cross-sectional area depending on the products should not be ignored in the identification of minute blood cells having a volume on the order of 20 to 400 fL.

For example, when the cross-sectional area of the aperture increases even only slightly, the ratio of the volume of blood cells to the capacity of the aperture decreases even if the blood cells have the same size, which in turn results in the pulse voltage height appearing lower than it should. Therefore, as shown in the graph of FIG. 9(b), when a specific standard threshold value Ks of pulse voltage height is fixedly used for each cartridge, a minute blood cell is sometimes regarded as a more minute noise particle and is not counted. Conversely, when the cross-sectional area of a replaced aperture decreases even only slightly, the pulse voltage height appears higher than it should, and a minute noise particle is sometimes counted as a larger blood cell.

On the other hand, in the determination based on the pulse voltage width, since an increase in the cross-sectional area of the aperture decreases the flow velocity within the aperture, blood cells show greater (wider) values of the pulse voltage width than they should for the same size. Therefore, when standard threshold value Ks is fixedly used for each cartridge, noise particles are sometimes counted and, when the aperture has a small cross-sectional area, blood cells are not counted in some cases.

It has been conventionally recognized of cartridge type blood cell measuring parts that the presence of great variation in the cross-sectional area of replacement apertures is not desirable. Measures to address this included decreasing variation in the cross-sectional area of apertures by achieving high precision based on a higher precision level, particularly, a lower size tolerance of the aperture in an attempt to enable fixed application of one standard threshold value to each cartridge. As a result, the production cost of a replacement cartridge was high.

The above-mentioned problems of counting error and high cost of cartridges due to the replacement of cartridges (particularly, replacement of aperture), that were found by the present inventor, can similarly occur not only for counting devices targeting blood cells but also general particle counting devices for practicing the electrical resistance method.

The object of the present invention is to provide a method and a device for counting particles that can solve the problems found by the present inventor himself and can obtain highly reliable measurement results even when a measuring part is replaced in a device used for practicing the electrical resistance method.

### SUMMARY OF THE INVENTION

The present inventor has conducted intensive studies in an attempt to solve the aforementioned problems associated with the changes in an aperture due to the replacement of the cartridge, and found the presence of a specific (intrinsic) parameter which is observable from the outside and varies according to the cross-sectional area of the aperture in the cartridge every time the cartridge is replaced, and envisaged the technical idea of adjusting, based on the parameter, the threshold value for determining noise and particle for each replaced aperture in the blood cell measuring part, and completed the present invention by establishing an adjustment method therefor.

Accordingly, the main configuration of the present invention is as follows.

(1) A method of counting particles in a sample liquid based on an electrical resistance method by using a flow channel, an aperture in the flow channel and a pair of electrodes across the aperture, which are provided as a replaceable cartridge, the method comprising:

adjusting a threshold value for determining a particle to be counted or a noise particle smaller than the same, to a specific threshold value for each cartridge, by using an externally observable parameter specific to each cartridge, the parameter varying according to the cross-sectional area of the aperture in the each cartridge.

(2) The particle counting method of (1), wherein in a volume-frequency distribution of the particles in the sample liquid, obtained by a cartridge used for measurement, a volume having the smallest frequency within a volume range, in which the threshold value for determining a particle to be counted or a noise particle smaller than the same exists, is adopted as the specific threshold value for the cartridge used for measurement.

(3) The particle counting method of (1), wherein the method is for counting the particles in the sample liquid based on each pulse voltage height obtained by the electrical resistance method,

the method comprising:

adjusting a standard threshold value of a pulse voltage height of (A) described below, so as to be proportional to a ratio (Vx/Vs) of (a) described below, and

adopting the adjusted standard threshold value as the specific threshold value for the cartridge.

(4) The particle counting method of (1), wherein the method is for counting the particles in the sample liquid based on each pulse voltage width obtained by the electrical resistance method,

the method comprising:

adjusting a standard threshold value of a pulse voltage width of (B) described below, so as to be inversely proportional to a ratio (Vx/Vs) of (a) described below, and adopting the adjusted standard threshold value as the specific threshold value for the cartridge.

(5) The particle counting method of (1), wherein the method is for counting the particles in the sample liquid based on each pulse voltage height obtained by the electrical resistance method,

the method comprising:

adjusting a standard threshold value of a pulse voltage height of (A) described below, so as to be inversely proportional to a ratio (Qx/Qs) of (b) described below, and adopting the adjusted standard threshold value as the specific threshold value for the cartridge.

(6) The particle counting method of (5), wherein the flow velocities Qx and Qs in the ratio (Qx/Qs) of (b) described below are respectively determined based on the time necessary for the sample liquid to move through a predetermined section in the flow channel at the downstream of the aperture.

(7) The particle counting method of (1), wherein the method is for counting the particles in the sample liquid based on each pulse voltage width obtained by the electrical resistance method,

the method comprising:

adjusting a standard threshold value of a pulse voltage width of (B) described below, so as to be proportional to a ratio (Qx/Qs) of (b) described below, and

adopting the adjusted standard threshold value as the specific threshold value for the cartridge.

(8) The particle counting method of (7), wherein the flow velocities Qx and Qs in the ratio (Qx/Qs) of (b) described below are respectively determined based on the time necessary for the sample liquid to move through a predetermined section in the flow channel at the downstream of the aperture.

(9) A particle counting device comprising at least a flow channel, an aperture in the flow channel and a pair of electrodes across the aperture, which are provided as a replaceable cartridge, and the device being configured to count particles in a sample liquid based on an electrical resistance method,

the particle counting device further comprising:

a computing part, configured to carry out an operation to adjust a threshold value for determining a particle to be counted or a noise particle smaller than the same, to a specific threshold value for each cartridge, by using an externally observable parameter specific to the each cartridge, the parameter varying according to the cross-sectional area of the aperture in the each cartridge.

(10) The particle counting device of (9), wherein the computing part is configured such that

in a volume-frequency distribution of the particles in the sample liquid, obtained by a cartridge used for the measurement, the computing part adopts a volume having the smallest frequency within a volume range, in which the threshold value for determining a particle to be counted or a noise particle smaller than the same exists, as the specific threshold value for the cartridge used.

(11) The particle counting device of (9), wherein the particle counting device is configured to count the particles in the sample liquid based on each pulse voltage height obtained by the electrical resistance method, and wherein

the computing part is configured

to adjust a standard threshold value of a pulse voltage height of (A) described below, so as to be proportional to a ratio (Vx/Vs) of (a) described below, and

to adopt the adjusted standard threshold value as the specific threshold value for the cartridge.

(12) The particle counting device of (9), wherein the particle counting device is configured to count the particles in the sample liquid based on each pulse voltage width obtained by the electrical resistance method, and wherein

the computing part is configured

to adjust a standard threshold value of a pulse voltage width of (B) described below, so as to be inversely proportional to a ratio (Vx/Vs) of (a) described below, and

to adopt the adjusted standard threshold value as the specific threshold value for the cartridge.

(13) The particle counting device of (9), wherein the particle counting device is configured to count the particles in the sample liquid based on each pulse voltage height obtained by the electrical resistance method, and wherein

the computing part is configured

to adjust a standard threshold value of a pulse voltage height of (A) described below, so as to be inversely proportional to a ratio (Qx/Qs) of (b) described below, and

to adopt the adjusted standard threshold value as the specific threshold value for the cartridge.

(14) The particle counting device of (9), wherein the particle counting device is configured to count the particles in the sample liquid based on each pulse voltage width obtained by the electrical resistance method, and wherein

the computing part is configured

to adjust a standard threshold value of a pulse voltage width of (B) described below, so as to be proportional to a ratio (Qx/Qs) of (b) described below, and

to adopt the adjusted standard threshold value as the specific threshold value for the cartridge.

(A) A standard threshold value of a pulse voltage height, which standard threshold value being predetermined for determining a particle to be counted or a noise particle smaller than the same, by using a standard aperture having a predetermined cross-sectional area.

(B) A standard threshold value of a pulse voltage width, which standard threshold value being predetermined for determining a particle to be counted or a noise particle smaller than the same, by using a standard aperture having a predetermined cross-sectional area.

(a) A ratio (Vx/Vs) of a voltage Vx to a standard voltage Vs, wherein

the voltage Vx is a voltage between electrodes when an aperture and a space between the electrodes in a cartridge for measurement are filled with the liquid in a sample liquid, and the standard voltage Vs is a voltage between electrodes when a standard aperture having a predetermined cross-sectional area and a space between the electrodes are filled with the liquid in a sample liquid.

(b) A ratio (Qx/Qs) of flow velocity Qx to flow velocity Qs, wherein

the flow velocity Qx is a flow velocity of a sample liquid traveling along a flow channel through an aperture in a cartridge for measurement, and

the flow velocity Qs is a flow velocity of the sample liquid traveling along the flow channel through a standard aperture having a predetermined cross-sectional area.

### BRIEF DESCRIPTION OF THE DRAWINGS

FIG. 1 is a block diagram showing a configuration example of a particle counting device of the present invention. In the example of the drawing, not only an aperture, but also a pair of electrodes and a flow channel are replaceable such that they are included in the cartridge. Illustrations of the structure of a tank for supplying a sample liquid in the direction of arrow and a flow channel receiving the sample liquid that passing through the aperture and then flowing in the arrow direction are omitted.

FIG. 2 is a block diagram showing a more detailed configuration example of the particle counting device of the present invention.

FIGS. 3(a) and 3(b) are perspective views showing a design example in which a measuring part body 10 and a cartridge 20 are removable (attachable and detachable) from the particle counting device of the present invention.

FIG. 4 is a view showing a detailed configuration example of a cartridge.

FIG. 5 is a perspective view showing a structural example of an aperture of the cartridge in FIG. 4.

FIG. 6 is a graph representation for depicting an operation of adjusting a standard threshold value Ks according to a first embodiment of the present invention, and setting it to be a specific threshold value K1 unique to each aperture.

FIGS. 7(a) and 7(b) are views depicting one example of a method for measuring the flow velocity of a sample liquid traveling through the aperture in fourth and fifth embodiments of the present invention.

FIGS. 8(a) and 8(b) are views for depicting a basic principle and an arrangement of an electrical resistance method. FIG. 8(a) shows an arrangement example of an aperture and electrodes, and FIG. 8(b) schematically shows variations in voltage between electrodes occurring when blood cells pass through the aperture.

FIG. 9(a) is a view for depicting the problem caused when a standard threshold value is applied to the cartridge, and FIG. 9(b) is a graph representation of a volume-frequency distribution of white blood cells obtained by the electrical resistance method.

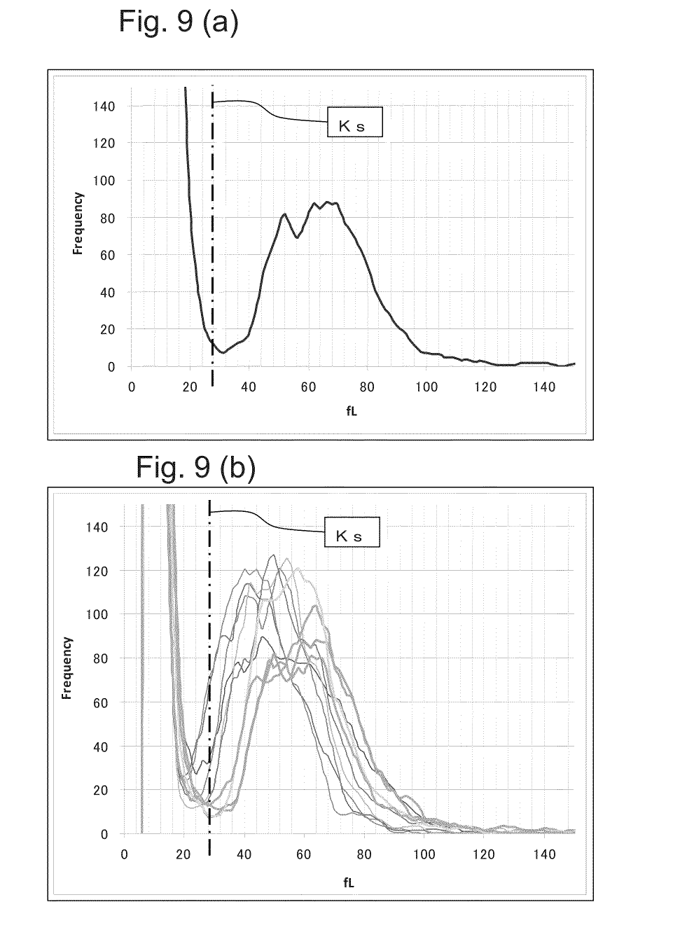

### DETAILED DESCRIPTION OF THE INVENTION

In the present invention, note was taken of an observable specific parameter that varies mainly due to a minor manufacturing error of the cross-sectional area of the aperture in the cartridge for use (aperture for use) and appears every time the cartridge is replaced. Then, the threshold value specific to the cartridge for use (specific threshold value) is determined utilizing the specific parameter, and used for the determination of a particle or a noise particle.

Since a threshold value specific to each cartridge is determined, even when the cross-sectional area of the aperture varies on each cartridge replacement, appropriate particle determination according to the variation can be performed, which in turn affords more accurate counting results than by conventional fixed use of one standard threshold value.

Conventionally, moreover, an attempt has been made to comply with the one standard threshold value by producing each cartridge with high precision, so that the one standard threshold value can be utilized fixedly. On the contrary, in the present invention, since the threshold value is determined according to the variation of the aperture for use and the specific threshold value of each cartridge is adapted to the cartridge, each cartridge does not need to be produced more highly precisely than necessary, and the production cost can be reduced.

In the following, the method of the present invention is described according to the embodiments of the measurement of the volume-frequency distribution of white blood cells in a sample liquid by the electrical resistance method, and the configuration of the device of the present invention is explained.

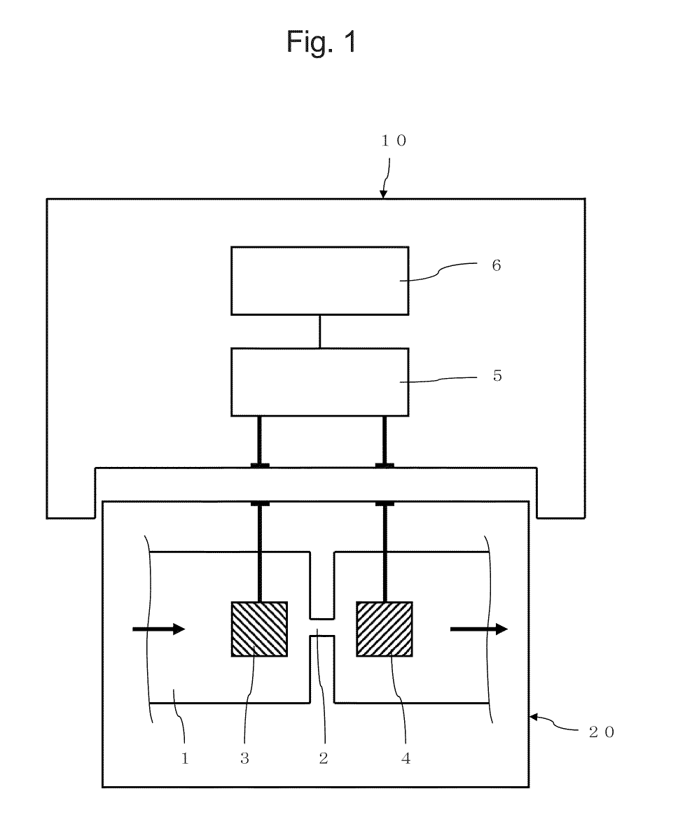

FIG. 1 is a block diagram showing a configuration example of the common part of a particle counting device according to the present invention. The device is for practicing the method according to the present invention. The device in any embodiment has a constitution including a measuring part body 10 and a cartridge 20, which is a replaceable blood cell measuring part freely removable (i.e., attachable and detachable) therefrom, as in the conventional cartridge-type devices, whereby the aperture can be replaced. The cartridge 20 as a blood cell measuring part has a constitution including at least a flow channel 1, an aperture 2 set within the flow channel, and a pair of electrodes 3, 4 provided across the aperture, wherein the particles in a sample liquid passing through the aperture in the flow channel 1 can be counted based on the electrical resistance method, in conjunction with control devices (connector part 5, computing part 6, and the like) provided in the measuring part body 10. In FIG. 1, two wirings (drawn with two thick lines) each extending from the pair of electrodes 3, 4 to the main body side and two wirings each extending from the connector part 5 to the cartridge side show that they are removably connected.

The prior art such as the above-mentioned patent documents and the like may be referred to for the basic configurations of flow channel 1, aperture 2, electrodes 3, 4, configuration such as a control device for applying voltage between electrodes from a constant-current power supply (not illustrated) through connector part 5, computing part 6 for counting particles by pulse voltage height or pulse voltage width that occur based on the electrical resistance method.

Of the processing configuration in the computing part, the parts characteristic of the present invention are described later according to each embodiment.

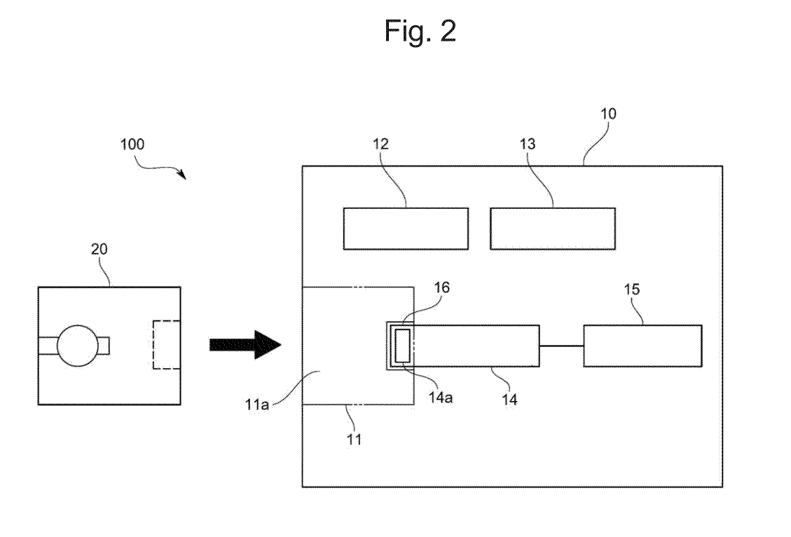

FIG. 2 is a block diagram showing a more detailed configuration example of the particle counting device according to the present invention, and directly quotes FIG. 1 of the above-mentioned JP-A-2011-180117. While the structure of each part shown in FIG. 2 of this application is also similar to that in FIG. 1 of JP-A-2011-180117, a computing part 15 provided according to the present invention has a different function which is a unique constitution of the present invention, since it is particularly configured to determine a specific threshold value.

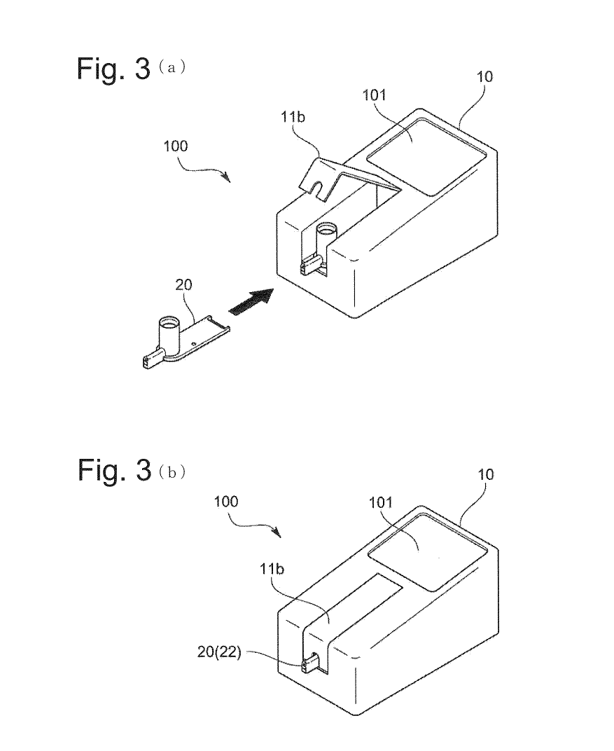

FIGS. 3(a) and 3(b) is are views showing a more detailed configuration example of the particle counting device according to the present invention, and directly reference FIG. 2 of the above-mentioned JP-A-2011-180117. While the measuring part body 10 and the cartridge 20 shown in FIGS. 3(a) and 3(b) are similar to those shown in FIG. 2 of the above-mentioned JP-A-2011-180117 in the design and the structure itself that confers removability, the function of the computing part provided according to the present invention is the unique constitution of the present invention, as in the case of FIG. 2.

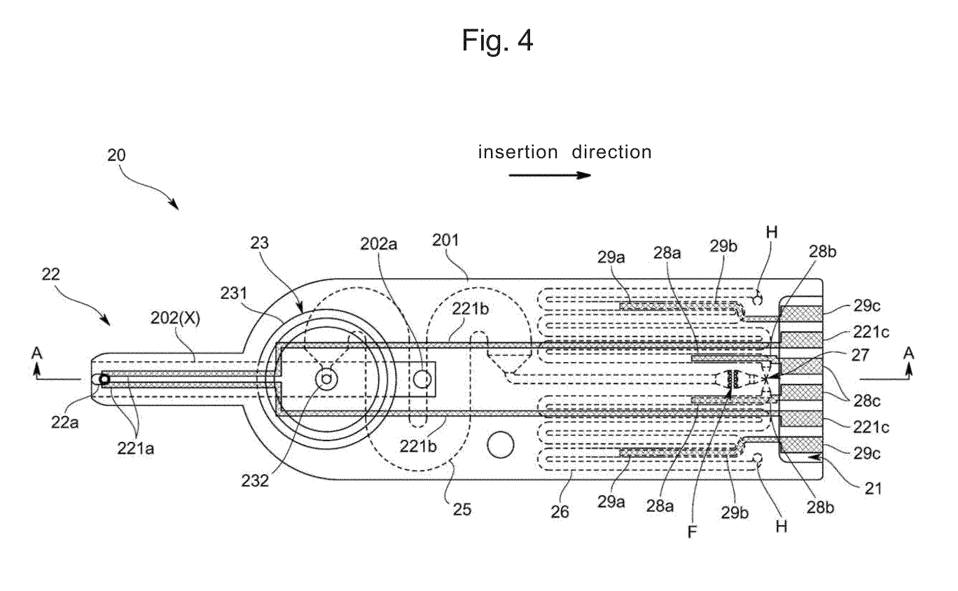

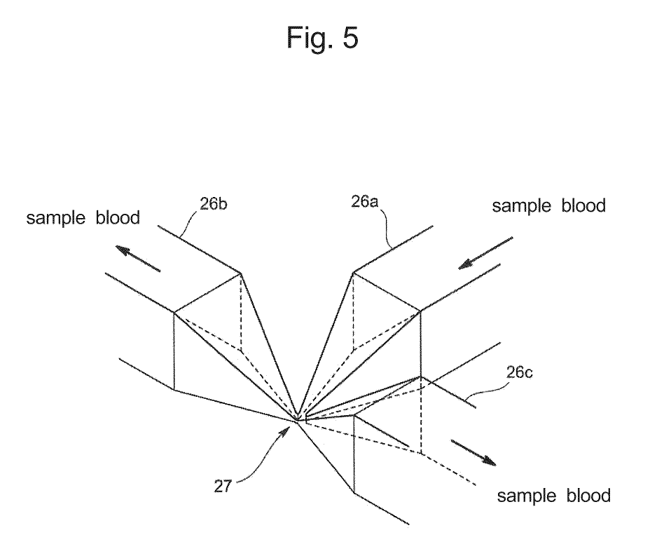

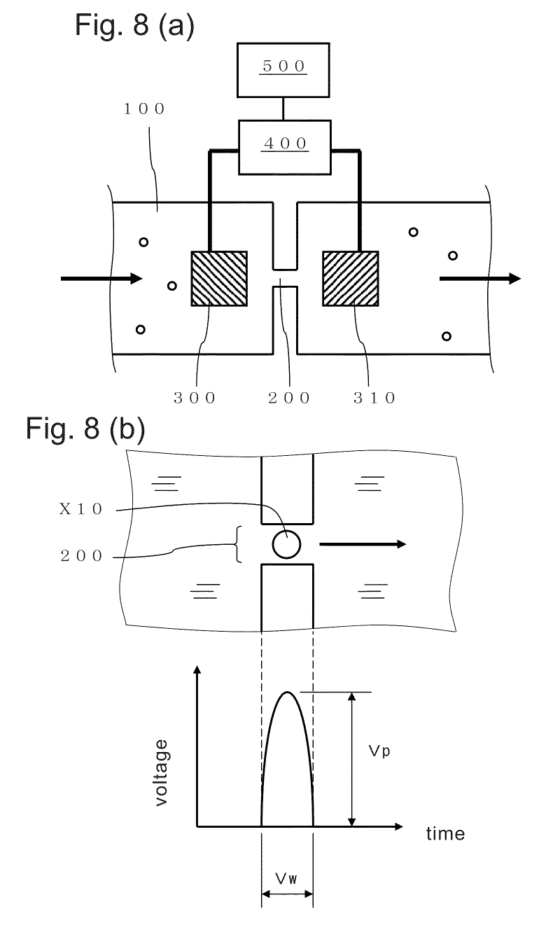

FIG. 4 shows an example of the detailed inside configuration of a cartridge, which has the same configuration as described in FIG. 4 of the above-mentioned JP-A-2011-180117. In the configuration example of this Figure, while the flow channel immediately after the aperture is branched in two directions, as shown in an enlarged view in FIG. 5, the principle itself of the particle counting based on the electrical resistance method is the same as that in the single flow channel of FIG. 1 and FIG. 8(a) of the present invention.

FIG. 5 is a perspective view showing in more detail the structure of FIG. 4 in which the flow channel immediately after the aperture in the cartridge is branched in two directions.

The configuration itself of the respective parts shown with reference symbols in FIG. 2 to FIG. 5 of the present application is described in detail in JP-A-2011-180117 except the function of the computing part, and therefore, a detailed explanation of each part is omitted in the following description. The device configuration described in FIG. 2 to FIG. 5 is merely one example, and may be any as long as it can count particles based on the electrical resistance method, by using a flow channel, an aperture, and electrodes.

In the method and the device of the present invention, particles in a sample liquid are counted on the basis of the electrical resistance method and using the flow channel 1, the aperture 2 in the flow channel, and the pair of electrodes 3, 4 across the aperture as described above. The flow channel 1, aperture 2, and electrodes 3, 4 are provided in a replaceable cartridge, and necessary sample liquid tanks and terminals for measurement circuits are provided as appropriate.

In the method of the present invention, note was taken of an observable specific parameter that varies mainly due to a minor error in the processing of the cross-sectional area of the aperture in the cartridge for use (aperture for use) and appears every time the cartridge is replaced. The threshold value specific to each cartridge for use (specific threshold value) is determined utilizing the specific parameter, and used for the determination of a particle or a noise particle. In the device of the present invention, moreover, the computing part is configured to function as a device for practicing the method of the present invention.

Examples of the observable specific parameter that varies and appears mainly due to a minor error in the processing of the cross-sectional area of the aperture for use includes, for example, the curve of a graph of the volume-frequency distribution that varies depending on the aperture for use (shifts in the small and large direction of the volume according to the aperture for use), electric properties between electrodes (impedance, voltage, etc.) when a sample liquid is filled between the electrodes, the flow velocity and flow amount of the liquid in a sample liquid that travels along the flow channel through the aperture for use and the like.

### First Embodiment of the Present Invention

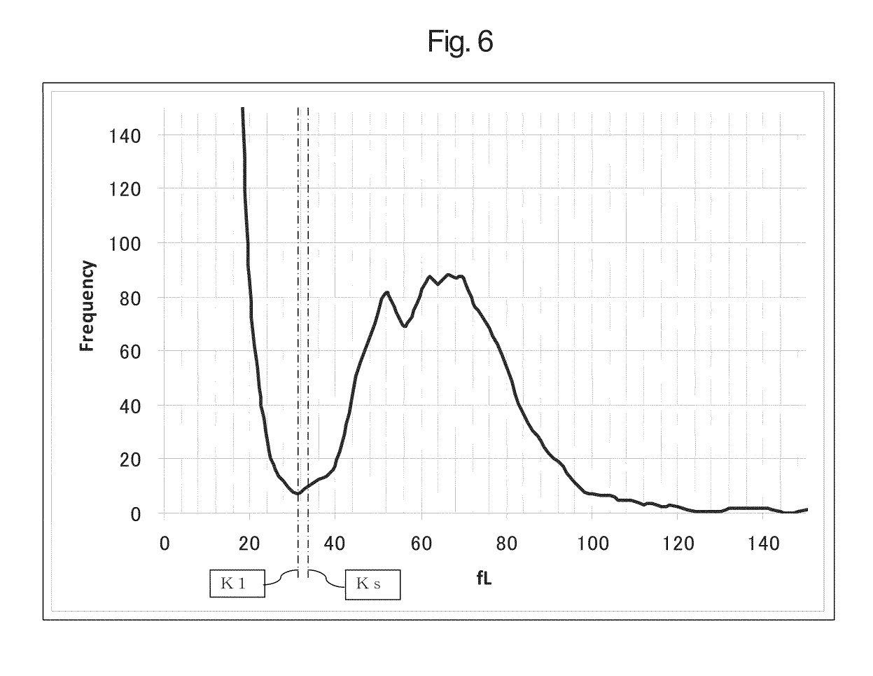

In the first embodiment of the particle counting method of the present invention, a specific threshold value is determined for each cartridge for use. In this embodiment, first, an electrical resistance method using a cartridge-type device illustrated in FIG. 1 to FIG. 5 is performed for a sample liquid containing white blood cells, which are the particles to be counted, to give the volume-frequency distribution of the particles shown in FIG. 6. Any of the pulse voltage height and the pulse voltage width may be used for the determination of the volume-frequency distribution.

Next, in a volume range (20 to 40 fL in the example of FIG. 6) where the threshold value for determining white blood cells (particles to be counted) or noise particles smaller than the same can exist, the volume of the smallest frequency shown with an alternate long and short dash line K1 in the graph of FIG. 6 is adopted as a threshold value specific to the cartridge for use (i.e., specific to the aperture for use) (specific threshold value) to be employed for the measurement, and used for the determination of a particle or a noise particle.

In the graph of the volume-frequency distribution of the particles, when the standard threshold value is shifted toward the left side beyond the volume of the smallest frequency (smaller volume), noise particles may be counted as the particles to be counted, and the count of the particles to be counted becomes larger than it should. Conversely, as shown in the graph of FIG. 6, when the standard threshold value Ks is shifted toward the right side beyond the volume of the smallest frequency (larger volume), the particles to be counted may not be counted, and the count of the particles to be counted becomes smaller than it should. Therefore, the volume of the smallest frequency becomes the most appropriate specific threshold value in the measurement results of the volume-frequency distribution by the aperture for use.

In contrast, conventionally, the magnitude of the frequency is not noted, and the standard threshold value Ks statistically predetermined is fixedly employed even when the cartridge is replaced. As a result, noise particles may be counted as the particles to be counted or the particles to be counted may not be counted. To solve this problem, cartridges having an aperture with high precision have been fabricated.

The adjustment of the threshold value in the first embodiment of the present invention solves such conventional problem and, as exemplarily shown in the graph of FIG. 6, a specific threshold value K1 is determined for each cartridge and used for the determination, without using the fixed standard threshold value Ks.

The setting method of the specific threshold value in the first embodiment of this method is effective not only for the determination of white blood cells or noise particles but also determination in the counting of particles such as red blood cells, blood platelets and the like.

Whether the particle on the threshold value is a white blood cell or a noise particle may be determined as appropriate, and the determination method only needs to be the same.

In the first embodiment of this method, it is more efficient to previously identify the volume range where the threshold value for determining white blood cells to be counted or noise particles smaller than the same can exist, when the volume of the smallest frequency is determined in the volume-frequency distribution of particles. In a preferred embodiment, the volume of the smallest frequency in the predetermined volume range is determined by the computing part.

The existence itself of the threshold value for determining a particle or a noise particle is known. It is also known that the volume range where the threshold value can exist is limited to a specific range according to the particle to be counted.

The volume range where the threshold value can exist can be statistically predetermined according to the sample and precision of the cartridge. For example, when white blood cells are counted, the volume range where the threshold value can exist is 10 to 40 fL, more narrowly limited to 20 to 40 fL.

In the first embodiment of this method, when there is only one volume of the smallest frequency in the volume-frequency distribution of the particles measured, the volume can be taken as the threshold value. In the actual volume-frequency distribution, however, the volume of the smallest frequency is not always one, and the smallest frequency may occur in succession. In addition, the distribution near the smallest frequency does not necessarily depict a simple convex downward curve, but there may occur many fine concaves and convexes of frequencies, thereby depicting a valley (convex downward) as a whole with frequencies. For example, there may be a plurality of smallest frequencies, between which larger frequencies are sandwiched to form concaves and convexes.

In such cases, a method of determining the volume of the smallest frequency includes, for example, assuming a curve approximate to the curve formed by the valley of frequencies, computing to calculate the peak (minimum value) thereof, and adopting the peak as the volume of the smallest frequency. When a plurality of smallest frequencies are present, the average of the volumes of the frequencies may be taken as the volume of the smallest frequency.

In the first embodiment of the present invention, various mathematical methods may be applied as appropriate to the curve forming the valley of frequencies, as described above, to determine the volume of the smallest frequency.

In the first embodiment of this method, a graph or table of the volume-frequency distribution as shown in FIG. 6 is not necessarily required for determination of the specific threshold value. That is, at the stage when the data set consisting of respective pulse voltage heights and frequencies thereof or the data set consisting of respective pulse voltage widths and frequencies thereof are obtained by measurements to give volume-frequency distribution, a predetermined volume range where the threshold value can exist is referred to, and the smallest frequency in the range is ascertained and determined to be the specific threshold value which is used for the determination of particles or noise particles.

In the first embodiment of this method, a graph or a table of the volume-frequency distribution as shown in FIG. 6 may be the final output, or only the number determined as the particles may be output.

In the present invention, it is important to determine the threshold value specific to the cartridge for use as described above. In the first embodiment, the computation itself for determining the volume of the smallest frequency may be performed by an operator, but is preferably performed automatically by a computing part such as a computer and the like. This also applies to the computation for adjustment in other embodiments described below.

The first embodiment of the particle counting device of the present invention is characterized in that it has a device structure explained using FIG. 1, and further, has a computing part configured to be able to work the first embodiment of the particle counting method of the present invention.

In a preferred embodiment, the computing part is constituted by a computer (e.g., one circuit board with a CPU, a memory, and the like mounted thereon) permitting accommodation in the measuring part body, and control of respective parts and computation are performed by programs executed by the computer. This also applies to computing parts in other embodiments. The connection and communication between the computer and external devices are obvious from the prior art.

As shown in FIG. 1, the computing part 6 (computing part 15 in FIG. 2) of this device is configured to work in conjunction with the constant-current power supply and the like to apply voltage to the electrodes of the replaced cartridge, count the particles in a sample liquid based on the electrical resistance method, and function as a means for obtaining the volume-frequency distribution.

The computing part 6 of this device is configured to function as a means for performing a computation to adopt the volume of the smallest frequency within the volume range, where the threshold value for determining particles or noise particles can exist, as the threshold value specific to the cartridge for use.

Moreover, the computing part 6 of the device is configured to function as a means for determining a particle or a noise particle by using the specific threshold value obtained by the above-mentioned computation, and outputting the counting results.

The computation method for determining the volume of the smallest frequency is as described in the explanation of the method.

The counting results may be output to a display provided on the measuring part body or an external display or printer.

### Second Embodiment of the Present Invention

The second embodiment of the particle counting method of the present invention is an embodiment of a method for counting particles in a sample liquid by a pulse voltage height based on the electrical resistance method, wherein the standard threshold value is adjusted by a unique method.

In the second embodiment of the present method, note was taken of an observable specific voltage between electrodes that varies, every time the cartridge is replaced and the aperture is changed, due to an error in the processing of the cross-sectional area of the aperture for use, and the standard threshold value of the pulse voltage height is adjusted utilizing the voltage between electrodes. More specifically, by utilizing the voltage between electrodes that is inversely proportional to the square of the cross-sectional area of the aperture when filled with the liquid in a sample liquid (for example, when the aperture has a large cross-sectional area, the voltage between electrodes appears low), a predetermined standard threshold value (the above-mentioned predetermined standard threshold value (A) above of pulse voltage height) is adjusted according to the variation ratio thereof (ratio (Vx/Vs) of (a) above), and used as the threshold value specific to the cartridge for use for the determination to perform counting.

An example of the specific step of adjusting the standard threshold value is as follows.

### [Determination of Standard Threshold Value of (A) Above]

In the second embodiment of the present invention, as in (A) above, a standard threshold value of the pulse voltage height for the determination of a particle or a noise particle is predetermined using a standard aperture having a predetermined cross-sectional area and standard electrodes provided in association therewith.

In the blood cell measuring part in general blood cell counting devices, the design value of the cross-sectional area of the aperture is selected from the range of about 0.005 to 0.008 mm² (in actual aperture for use, the cross-sectional area varies within the tolerance range around the selected design value thereof). The design value of the voltage between electrodes, which is applied from the constant-current power supply when the flow channel including the aperture is filled with the liquid in a sample liquid, is selected from the range of about 10 to 30 V (the voltage to be actually applied varies within the tolerance range around the selected design value thereof). Particularly, in a palmtop-type device as shown in JP-A-2011-180117, the design value of the cross-sectional area of the aperture is appropriately selected from the range of about 0.001 to 0.008 mm² by reference to the experimental data, etc. The standard aperture having a predetermined cross-sectional area may have a design value closer to the selected design value, and may be an aperture for a standard device which is especially made with high precision to be close to the selected design value, or an aperture closest to the design value, which is selected from many products. This also applies to other embodiments of the present invention.

The design value of the voltage between electrodes when the flow channel including the aperture is filled with a sample liquid is selected from the range of about 10 to 30 V.

Since the variations in the cross-sectional area of the aperture to be replaced are conventionally controlled to fall within the range of about −0.0002 to +0.0002 mm² of the selected design value of the cross-sectional area, when the standard aperture has a size in the center of the design value, the variations in the voltage between electrodes Vx is within the range of about −15 to +15V.

In counting white blood cells, the pulse voltage height of each particle obtained with the cross-sectional area of the aperture as described above and the voltage applied from the constant-current power supply is, for example, about 0.4 to 3.1 V for particles having a volume of 30 to 200 fL.

The pulse voltage width to be the standard threshold value is selected from about 0.3 to 0.6 V in the range of the pulse voltage height corresponding to the volumes of 20 to 40 fL.

### [Determination of Ratio (Vx/Vs) of (A) Above]

First, as in the above-mentioned (a) described as the main constitution of the present invention, using a standard cartridge (or a standard particle counting device) containing a standard aperture having a known cross-sectional area (having an opening shape and a cross-sectional area close to those designed) and a pair of electrodes provided in association therewith, the flow channel including the standard aperture is filled in advance with a liquid similar to the liquid part of an actual sample liquid, and the voltage between electrodes in that state is measured, and taken as the standard voltage (hereinafter to be also referred to as “standard voltage between electrodes”) Vs that can be referred to.

Next, using a cartridge for use, containing an aperture for use, which is to be employed for the actual measurement, the flow channel including the aperture for use is filled in the same manner as above with the liquid part of a sample liquid, and the voltage between electrodes in that state is measured, and taken as a voltage specific to the cartridge for use (hereinafter to be also referred to as the specific voltage between electrodes) Vx.

In an actual measurement, the specific voltage between electrodes Vx may be measured either before or after the blood cell counting, or during the blood cell counting, the voltage (the pulse voltage) between electrodes is generated. In a preferred embodiment, the measurement is performed automatically by a device after setting of the sample liquid and according to the input of the instructions by a measurement operator, and the like.

When Vx is measured before blood cell counting and the threshold value is adjusted before the counting, accurate counting is possible from the beginning, which is preferable since post processing for subsequent adjustment of the counting results and accumulation of the count data for post processing are not necessary.

### [Adjustment of Standard Threshold Value]

As described above, when the cross-sectional area of the aperture for use is larger than that of the standard aperture, the specific voltage between electrodes Vx appears at a value smaller than the standard voltage between electrodes Vs. Thus, when the ratio (Vx/Vs) of (a) above is smaller than 1, it is proved that the cross-sectional area of the aperture for use for the measurement is larger than that of the standard aperture.

On the other hand, as described using FIGS. 8(a) and 8(b), when the cross-sectional area of the aperture for use is large, all the pulse voltage heights of the measured particles are to be measured as lower than by the use of the standard aperture. Therefore, the threshold value for determination also needs to be shifted to a lower value along therewith. In other words, when the ratio (Vx/Vs) in (a) above is smaller than 1, the standard threshold value should be adjusted to a lower value and used for the determination as the threshold value specific to the cartridge for use. Conversely, when the ratio (Vx/Vs) is larger than 1, the standard threshold value should be adjusted to a higher value.

In the second embodiment, therefore, the standard threshold value of the pulse voltage height of (A) above is adjusted to be proportional to the ratio (Vx/Vs) of (a) above and used as the threshold value specific to the cartridge for use. As a specific way of adjustment, the standard threshold value is directly multiplied by the ratio (Vx/Vs), and adopted as the specific threshold value.

The measurements and computations as described above are preferably constituted to be performed automatically by the computing part in response to the input, by the user, of the signal for starting the measurement and computation, after replacement of the cartridge. This also applied to other embodiments of the present invention.

The second embodiment of the particle counting device of the present invention is characterized in that it has a device structure explained using FIG. 1, is configured to count particles in a sample liquid based on the pulse voltage height by the electrical resistance method, and further, has a computing part configured to be able to practice the second embodiment of the particle counting method of the present invention explained above.

The basic configuration of the device is similar to that of the first embodiment except for the function of the computing part. In this embodiment, however, the function of obtaining the volume-frequency distribution is not necessarily required, and the device only needs to have at least the function of determining a particle or a noise particle, and counting the particles.

In the second embodiment of the device, the standard threshold value of the pulse voltage height of (A) above and the standard voltage between electrodes Vs to obtain the ratio (Vx/Vs) of (a) above are given as preset data to be referred to by the computing part.

The configuration of the device for providing the standard threshold value and the standard voltage between electrodes is not particularly limited. For example, the device may include stored data in a memory within the device, data received from an external source through a communication means, or stored data in on-device memory with appropriate updating from an external source through such communication means.

Furthermore, in the second embodiment of the device, the computing part 6 in FIG. 1 (computing part 15 in FIG. 2) is configured to function as a means for measuring the specific voltage between electrodes Vx when the aperture for use is filled with a sample liquid and between electrodes. The step of measuring the specific voltage between electrodes Vx is as described above.

Moreover, the computing part is configured to function as a means for computing the ratio (Vx/Vs) of (a) above from the measured specific voltage between electrodes Vx and the given standard voltage between electrodes Vs, and adjusting the standard threshold value to be proportional to the ratio (Vx/Vs).

A specific computing step for the adjustment is multiplying the standard threshold value by the ratio (Vx/Vs), as explained for the above-mentioned method.

Moreover, the computing part is configured to function as a means for determining a particle or a noise particle by using the adjusted threshold value, and outputting the counting results.

### Third Embodiment of the Present Invention

The third embodiment of the particle counting method of the present invention is an embodiment of a method for counting particles in a sample liquid based on a pulse voltage width by the electrical resistance method, wherein the standard threshold value is adjusted by a unique method.

In the third embodiment of this method, similar to the second embodiment described above, note was taken of an observable specific voltage between electrodes that varies, every time the cartridge is replaced and the aperture is changed, due to an error in the processing of the cross-sectional area of the aperture for use, and the standard threshold value of the pulse voltage width is adjusted utilizing the specific voltage between electrodes. More specifically, a predetermined standard threshold value (the above-mentioned standard threshold value (B) of pulse voltage width) is adjusted according to the ratio (Vx/Vs) of the above-mentioned (a), and used as the threshold value specific to the cartridge for use to perform counting.

An example of the specific step of adjusting the standard threshold value to give a specific threshold value is as follows.

### [Determination of Standard Threshold Value of (B) Above]

In the third embodiment of the present invention, as in (B) above, a standard threshold value of the pulse voltage width for the determination of a particle or a noise particle is predetermined using a standard aperture having a predetermined cross-sectional area.

The design value and variations of the cross-sectional area of the aperture and the design value and variations of the voltage between electrodes in general blood cell counting devices are as described in the second embodiment.

In counting white blood cells, the pulse voltage width of each particle obtained with the cross-sectional area of the aperture as described above and the voltage applied from the constant-current power supply is, for example, about 10 psec to 50 psec for particles having a volume of 30 to 200 fL (which varies depending on the width of the aperture). The pulse voltage width to be the standard threshold value is selected from about 5 to 10 μs for the section of 20 to 40 fL.

### [Determination of Ratio (Vx/Vs) of (A) Above and Adjustment of Standard Threshold Value]

The method for determining the ratio (Vx/Vs) of (a) above is the same as in the second embodiment.

As described above, when the cross-sectional area of the aperture for use is larger than that of the standard aperture, the specific voltage between electrodes Vx appears at a value smaller than the standard voltage between electrodes Vs, resulting in ratio (Vx/Vs)<1. Thus, when the ratio (Vx/Vs) in (a) above is smaller than 1, it is proved that the cross-sectional area of the aperture for use for the measurement is larger than that of the standard aperture.

On the other hand, when the cross-sectional area of the aperture for use is larger than that of the standard aperture, the flow velocity decreases in the aperture, and all the pulse voltage widths of the measured particles are to be measured as greater values than by the use of the standard aperture. Therefore, the threshold value for determination also needs to be shifted to a wider value along therewith. In other words, when the ratio (Vx/Vs) in (a) above is smaller than 1, the standard threshold value of the pulse voltage width should be adjusted to a larger (wider) value and used for the determination as the threshold value specific to the cartridge for use. Conversely, when the ratio (Vx/Vs) is larger than 1, the standard threshold value should be adjusted to a smaller (narrower) value.

In the third embodiment, therefore, the standard threshold value of the pulse voltage width of (B) above is adjusted to be inversely proportional to the ratio (Vx/Vs) of (a) above and adopted as the threshold value specific to the cartridge for use. As a specific way of adjustment, the standard threshold value is multiplied by the inverse (reciprocal number) of the ratio (Vx/Vs), and used as the specific threshold value.

The third embodiment of the particle counting device of the present invention is the same as the above-mentioned second embodiment except the function of the computing part.

Also in the third embodiment of the device, the standard threshold value of the pulse voltage width of (B) above and the standard voltage between electrodes Vs to obtain the ratio (Vx/Vs) of (a) above are given as preset data to be referred to by the computing part. The embodiment for providing the standard threshold value and the standard voltage between electrodes is the same as that in the above-mentioned second embodiment.

In addition, the computing part is configured to function as a means for measuring the specific voltage between electrodes Vx, as in the above-mentioned second embodiment.

In the third embodiment of the device, the computing part is configured to function as a means for computing the ratio (Vx/Vs) of (a) above from the measured specific voltage between electrodes Vx and the given standard voltage between electrodes Vs, and adjusting the standard threshold value of the pulse voltage width of (B) above to be inversely proportional to the ratio (Vx/Vs).

A specific computing step for the adjustment is multiplying the standard threshold value by the inverse of the ratio (Vx/Vs), as explained for the above-mentioned method.

Moreover, the computing part is configured to function as a means for determining a particle or a noise particle by using the adjusted threshold value, and outputting the counting results, as in the above-mentioned second embodiment.

### Fourth Embodiment of the Present Invention

The fourth embodiment of the particle counting method of the present invention is, like the second embodiment, an embodiment of a method for counting particles in a sample liquid based on a pulse voltage height by the electrical resistance method, wherein the standard threshold value is adjusted; however, it is different from the second embodiment in the parameter used for adjusting the threshold value.

In the fourth embodiment of the method, note was taken of an observable flow velocity of a sample liquid that travels in the flow channel through the aperture that varies, every time the cartridge is replaced and the aperture is changed, due to an error in the processing of the cross-sectional area of the aperture for use, and the standard threshold value of the pulse voltage height is adjusted utilizing the flow velocity. For example, a larger cross-sectional area of the aperture permits a greater amount of a sample liquid to flow, and therefore, the flow velocity of the sample liquid traveling in the flow channel through such aperture becomes higher. Hence, the standard threshold value of (A) above is adjusted according to the ratio (ratio of (b) above) of the flow velocity of the sample liquid traveling in the flow channel through the aperture for use (specific flow velocity) Qx and the flow velocity of the sample liquid traveling in the flow channel through the standard aperture (standard flow velocity) Qs, and used for the counting as the threshold value specific to the cartridge for use.

A method for determining the standard threshold value of (A) above in advance is the same as that in the second embodiment.

A method for determining the ratio (Qx/Qs) of (b) above, and a method for adjusting the standard threshold value to give a specific threshold value are as described below.

First, as in the above-mentioned (b) described as the main constitution of the present invention, using a standard cartridge (or a standard particle counting device) containing a flow channel, a standard aperture having a known cross-sectional area and a pair of electrodes provided in association therewith, a sample liquid the same as the actual sample liquid is flown in advance in the flow channel, and the standard flow velocity Qs of the sample liquid traveling through the flow channel after passing the standard aperture is measured and stored so that the computing part can refer to.

The flow velocity here is a travel distance per unit time when a sample liquid travels along the flow channel. A time required for passing a particular section of the flow channel and the like can be used instead of the flow velocity. When the required time is used for the adjustment instead of the flow velocity, an appropriate conversion such as conversion to the inverse and the like can be performed. Even when the required time as the inverse of the flow velocity is used, the substantial processing of the adjustment is practically the same as the process of adjusting the standard threshold value to be in inverse proportion to the flow velocity, and this is encompassed in the present invention.

A concrete method of measuring the flow velocity of the sample liquid traveling in the flow channel through the aperture is described later.

Next, using a cartridge containing an aperture for use, which is to be employed for the actual measurement, the flow channel including the cartridge containing the aperture for use is filled in the same manner as above with a sample liquid, and the specific flow velocity Qx of the sample liquid traveling through the flow channel after passing the aperture for use is measured.

In actual counting using the cartridge, the specific flow velocity Qx may be measured either before or after the blood cell counting after replacement of the cartridge, or during the blood cell counting by flowing a sample liquid containing particles.

In a preferred embodiment, the measurement of the specific flow velocity Qx is performed automatically by a device after setting of the sample liquid and according to the input of the instructions to start the measurement by a measurement operator (user), and the like. In one embodiment, moreover, the specific flow velocity Qx may be measured during inspection (pre-shipment inspection), adjustment and the like in the production process of replacement cartridge, the value may be recorded in bar codes, IC chips, or the like to be readable by the measuring part body, and the measuring part body reads the value.

### [Adjustment of the Standard Threshold Value]

When the cross-sectional area of the aperture for use is larger than that of the standard aperture, the specific flow velocity Qx of the sample liquid traveling through the flow channel after passing through the aperture also appears as a higher (faster) value. Therefore, when the ratio (Qx/Qs) of (b) above is larger than 1, it is proved that the cross-sectional area of the aperture in the cartridge for the measurement is larger than that of the standard aperture.

On the other hand, as in the second embodiment, when the cross-sectional area of the aperture for use is large, the pulse voltage heights of the measured particles are measured as lower than by the use of the standard aperture. Therefore, the threshold value for determination also needs to be shifted to a lower value along therewith.

In other words, when the ratio (Qx/Qs) of (b) above is larger than 1, the standard threshold value should be adjusted to a lower value and used for the determination as the threshold value specific to the cartridge for use. Conversely, when the ratio (Qx/Qs) is smaller than 1, the standard threshold value should be adjusted to a higher value.

In the fourth embodiment, therefore, the standard threshold value of the pulse voltage height of (A) above is adjusted to be inversely proportional to the ratio (Qx/Qs) of (b) above and adopted as the threshold value specific to the cartridge for use. As a specific way of adjustment, the standard threshold value is multiplied by the inverse (reciprocal number) of the ratio (Qx/Qs), and used as the specific threshold value.

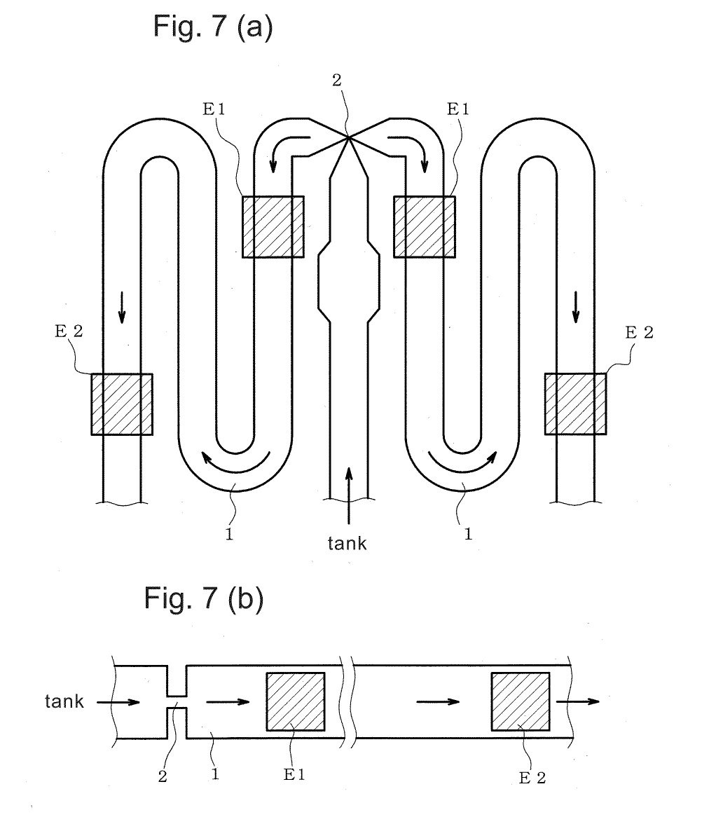

FIGS. 7(a) and 7(b) show views explaining one example of a method and a device for measuring the flow velocity of a sample liquid traveling in the flow channel through the aperture.

The aperture and the flow channel shown in FIG. 7(a) schematically show the branched types shown in FIG. 4 and FIG. 5, where the flow channel branched at the downstream of the aperture is in fact longer and has more windings. The example schematically shown in FIG. 7(b) has a single flow channel (not branched) after the aperture. In this case, also, the flow channel at the downstream of the aperture is in fact longer and has more windings.

The cartridge is a replaceable part containing a flow channel, an aperture, and electrodes, whereas a driving source that generates force (generally suction force) to cause a sample liquid to flow in the flow channel is in a common part which is provided on the main body of the device (measuring part body).

As shown in FIG. 7(a) and FIG. 7(b), electrodes E1, E2 of a sensor that detects the sample liquid are provided at the initial and final portions of the predetermined sections of the flow channel 1 at the downstream side of the aperture 2, and the sensor can detect the arrival of the sample liquid at the electrodes sensor after passing the aperture. Upon receipt of a signal teaching the arrival of the sample liquid at the electrode E1, the computing part measures the time necessary for the sample liquid to arrive at the electrode E2, and computes the flow velocity from the required time and the distance of the predetermined section.

In the fourth embodiment of the method, a standard cartridge (or a standard particle counting device) containing a flow channel, a standard aperture having a known cross-sectional area and a pair of electrodes provided in association therewith is configured as shown in FIGS. 7(a) and 7(b), and the standard flow velocity Qs is measured in advance and stored so that the computing part can refer to. A cartridge to be replaced is also configured as shown in FIGS. 7(a) and 7(b), the specific flow velocity Qx is measured, the ratio (Qx/Qs) of (b) above is determined and used for adjusting the standard threshold value of the pulse voltage height of (A) above.

As described above, while the required time may be directly used as the coefficient of adjustment instead of the flow velocity, since the value of the flow velocity and the value of the required time are in an inverse relationship, an appropriate processing such as conversion to the inverse (reciprocal number) is necessary.

While the flow velocity of the sample liquid that travels in the flow channel through the aperture varies depending on the design value of the cross-sectional area of the aperture and the cross-sectional area of the flow channel thereafter, the standard flow velocity is generally about 1 m/sec to 10 m/sec. In the case of the device of the above-mentioned JP-A-2011-180117, for example, the standard flow velocity is about 2 m/sec.

The fourth embodiment of the particle counting device of the present invention is the same as in the above-mentioned second embodiment except the above-mentioned configuration of the cartridge enabling measurement of the flow velocity and the function of the computing part that computes the flow velocity.

In the fourth embodiment of the device, the standard threshold value of the pulse voltage height of (A) above and the standard flow velocity Qs are given as preset data referable by the computing part. The embodiment for providing the standard threshold value and the standard flow velocity is the same as that in the above-mentioned second embodiment.

In the fourth embodiment of the device, a flow channel provided with electrodes of a sensor that detects a sample liquid, as shown in FIG. 7(a) or FIG. 7(b), is set as the flow channel of the cartridge 20 shown in FIG. 1, and the computing part 6 in FIG. 1 (computing part 15 in FIG. 2) is configured to function as a means for computing the specific flow velocity Qx of the sample liquid after passing the aperture for use.

Moreover, the computing part is configured to function as a means for computing the ratio (Qx/Qs) of (B) above from the computed specific flow velocity Qx and the given standard flow velocity Qs, and adjusting the standard threshold value to be inversely proportional to the ratio (Qx/Qs).

A specific computing step for the adjustment is multiplying the standard threshold value by the inverse of the ratio (Qx/Qs), as explained for the above-mentioned method.

Moreover, the computing part is configured to function as a means for determining a particle or a noise particle by using the adjusted threshold value, and outputting the counting results.

### Fifth Embodiment of the Present Invention

The fifth embodiment of the particle counting method of the present invention is, like the third embodiment, an embodiment of a method of counting particles in a sample liquid by a pulse voltage width based on the electrical resistance method; however, it is similar to the fourth embodiment in the parameter used for adjusting the threshold value.

In the fifth embodiment of the method, as in the above-mentioned fourth embodiment, note was taken of the ratio (Qx/Qs) of (b) above that varies every time the blood cell measuring part is replaced and the aperture is changed, due to an error in the processing of the cross-sectional area of the aperture for use, and the standard threshold value of the pulse voltage width of (B) above is adjusted utilizing the ratio.

A method for determining the standard threshold value of (B) above in advance is the same as that in the third embodiment. In addition, a method for determining the ratio (Qx/Qs) of (b) above is the same as to that in the fourth embodiment.

As described in the fourth embodiment, when the cross-sectional area of the aperture for use is large, the specific flow velocity Qx of the sample liquid traveling through the flow channel after passing through the aperture also appears as a higher (faster) value. Therefore, when the ratio (Qx/Qs) of (b) above is larger than 1, it is proved that the cross-sectional area of the aperture in the cartridge for the measurement is larger than that of the standard aperture.

On the other hand, as in the third embodiment, when the cross-sectional area of the aperture for use is larger than that of the standard aperture, the flow velocity decreases in the aperture, and all the pulse voltage widths of the measured particles are measured as wider than by the use of the standard aperture. Therefore, the threshold value for determination also needs to be shifted to a wider value along therewith. In other words, when the ratio (Qx/Qs) of (b) above is larger than 1, the standard threshold value of the pulse voltage width should be adjusted to a larger (wider) value and used for the determination as the threshold value specific to the cartridge for use. Conversely, when the ratio (Qx/Qs) is smaller than 1, the standard threshold value should be adjusted to a smaller (narrower) value.

In the fifth embodiment, therefore, the standard threshold value of the pulse voltage width of (B) above is adjusted to be proportional to the ratio (Qx/Qs) of (b) above and used as the threshold value specific to the cartridge for use. As a specific way of adjustment, the standard threshold value is directly multiplied by the ratio (Qx/Qs), and used as the specific threshold value.

The fifth embodiment of the particle counting device of the present invention is the same as in the above-mentioned fourth embodiment except the function of the computing part that amends the standard threshold value.

The computing part is configured to function as a means for computing the ratio (Qx/Qs) of (B) above from the computed specific flow velocity Qx and the given standard flow velocity Qs, and adjusting the standard threshold value to be proportional to the ratio (Qx/Qs).

A detailed computing step for the adjustment is multiplying the standard threshold value by the ratio (Qx/Qs) as described in the above-mentioned explanation of the method.

Moreover, the computing part is configured to function as a means for determining a particle or a noise particle by using the adjusted threshold value, and outputting the counting results.

In the present invention, the particles to be counted by the electrical resistance method are not specifically limited, and may be minute particles, liposome, and the like that encapsulate a drug. However, when the particles to be counted are red blood cells, blood platelets, white blood cells and the like that more importantly require distinction from noise particles such as air bubbles, the usefulness of the present invention becomes more remarkable.

When blood cells are counted by the electrical resistance method, sample blood is treated with a hemolysis reagent where necessary (particularly when only white blood cells are counted, etc.), further subjected to contraction, expansion, and deformation, and diluted about 200- to 20000-fold with a diluent (electrolyte solutions of sodium chloride, potassium chloride, etc. and, in some cases, hemolitic agents such as quaternary ammonium salt, saponin, etc.), which is the liquid part of the sample liquid, to give a sample liquid.

Preparation of a sample liquid, configuration of a blood cell counting device, voltage to be applied, plotting of counting results in a graph, and the like for performing the electrical resistance method by using an aperture are obvious from the prior art.

According to the present invention, a particle counting method capable of affording highly reliable measurement results and a device therefor can be provided, since a threshold value appropriate for individual cartridge can be determined even when the measuring part including an aperture in a device for performing the electrical resistance method is in the form of a cartridge and replaced. In addition, since the shape and size of respective parts (especially, aperture) of a replacement cartridge do not need to be produced with excessively high precision, even a replacement cartridge produced at a relatively low cost can provide highly dependable measurement results.

What is claimed is:

1. A method of counting particles in a sample liquid based on an electrical resistance method by using a flow channel, an aperture in the flow channel and a pair of electrodes across the aperture, which are provided as a replaceable cartridge, the method comprising:
adjusting a threshold value for determining a particle to be counted or a noise particle smaller than the particle to be counted, to a specific threshold value for each cartridge, by using an externally observable parameter specific to each cartridge, the parameter varying according to the cross-sectional area of the aperture in the each cartridge.

2. The particle counting method according to claim 1, wherein
in a volume-frequency distribution of the particles in the sample liquid, obtained by a cartridge used for measurement, a volume having the smallest frequency within a volume range, in which the threshold value for determining a particle to be counted or a noise particle smaller than the particle to be counted exists, is adopted as the specific threshold value for the cartridge used for measurement.

3. The particle counting method according to claim 1, wherein the method is for counting the particles in the sample liquid based on each pulse voltage height obtained by the electrical resistance method,
the method comprising:
adjusting a standard threshold value of a pulse voltage height of (A) described below, so as to be proportional to a ratio (Vx/Vs) of (a) described below, and
adopting the adjusted standard threshold value as the specific threshold value for the cartridge:
(A) a standard threshold value of a pulse voltage height, which standard threshold value is predetermined for determining a particle to be counted or a noise particle smaller than the particle to be counted, by using a standard aperture having a predetermined cross-sectional area,
(a) a ratio (Vx/Vs) of a voltage Vx to a standard voltage Vs, wherein
the voltage Vx is a voltage between electrodes when an aperture and a space between the electrodes in a cartridge for measurement are filled with the liquid in a sample liquid, and
the standard voltage Vs is a voltage between electrodes when a standard aperture having a predetermined cross-sectional area and a space between the electrodes are filled with the liquid in a sample liquid.

4. The particle counting method according to claim 1, wherein the method is for counting the particles in the sample liquid based on each pulse voltage width obtained by the electrical resistance method,
the method comprising:
adjusting a standard threshold value of a pulse voltage width of (B) described below, so as to be inversely proportional to a ratio (Vx/Vs) of (a) described below, and
adopting the adjusted standard threshold value as the specific threshold value for the cartridge:
(B) a standard threshold value of a pulse voltage width, which standard threshold value being predetermined for determining a particle to be counted or a noise particle smaller than the particle to be counted, by using a standard aperture having a predetermined cross-sectional area,
(a) a ratio (Vx/Vs) of a voltage Vx to a standard voltage Vs, wherein
the voltage Vx is a voltage between electrodes when an aperture and a space between the electrodes in a cartridge for measurement are filled with the liquid in a sample liquid, and
the standard voltage Vs is a voltage between electrodes when a standard aperture having a predetermined cross-sectional area and a space between the electrodes are filled with the liquid in a sample liquid.

5. The particle counting method according to claim 1, wherein the method is for counting the particles in the sample liquid based on each pulse voltage height obtained by the electrical resistance method,
the method comprising:
adjusting a standard threshold value of a pulse voltage height of (A) described below, so as to be inversely proportional to a ratio (Qx/Qs) of (b) described below, and
adopting the adjusted standard threshold value as the specific threshold value for the cartridge:
(A) a standard threshold value of a pulse voltage height, which standard threshold value being predetermined for determining a particle to be counted or a noise particle smaller than the particle to be counted, by using a standard aperture having a predetermined cross-sectional area,
(b) a ratio (Qx/Qs) of flow velocity Qx to flow velocity Qs, wherein
the flow velocity Qx is a flow velocity of a sample liquid traveling along a flow channel through an aperture in a cartridge for measurement, and
the flow velocity Qs is a flow velocity of the sample liquid traveling along the flow channel through a standard aperture having a predetermined cross-sectional area.

6. The particle counting method according to claim 5, wherein the flow velocities Qx and Qs in the ratio (Qx/Qs) of (b) above are respectively determined based on the time necessary for the sample liquid to move through a predetermined section in the flow channel at the downstream of the aperture.

7. The particle counting method according to claim 1, wherein the method is for counting the particles in the sample liquid based on each pulse voltage width obtained by the electrical resistance method,
the method comprising:
adjusting a standard threshold value of a pulse voltage width of (B) described below, so as to be proportional to a ratio (Qx/Qs) of (b) described below, and
adopting the adjusted standard threshold value as the specific threshold value for the cartridge:
(B) a standard threshold value of a pulse voltage width, which standard threshold value being predetermined for determining a particle to be counted or a noise particle smaller than the particle to be counted, by using a standard aperture having a predetermined cross-sectional area.
(b) a ratio (Qx/Qs) of flow velocity Qx to flow velocity Qs, wherein
the flow velocity Qx is a flow velocity of a sample liquid traveling along a flow channel through an aperture in a cartridge for measurement, and
the flow velocity Qs is a flow velocity of the sample liquid traveling along the flow channel through a standard aperture having a predetermined cross-sectional area.

8. The particle counting method according to claim 7, wherein the flow velocities Qx and Qs in the ratio (Qx/Qs) of (b) above are respectively determined based on the time necessary for the sample liquid to move through a predetermined section in the flow channel at the downstream of the aperture.

9. A particle counting device comprising at least a flow channel, an aperture in the flow channel and a pair of electrodes across the aperture, which are provided as a replaceable cartridge, and the device being configured to count particles in a sample liquid based on an electrical resistance method,
the particle counting device further comprising:
a computing part, configured to carry out an operation to adjust a threshold value for determining a particle to be counted or a noise particle smaller than the particle to be counted, to a specific threshold value for each cartridge, by using an externally observable parameter specific to the each cartridge, the parameter varying according to the cross-sectional area of the aperture in the each cartridge.

10. The particle counting device according to claim 9, wherein the computing part is configured such that
in a volume-frequency distribution of the particles in the sample liquid, obtained by a cartridge used for measurement, the computing part adopts a volume having the smallest frequency within a volume range, in which the threshold value for determining a particle to be counted or a noise particle smaller than the particle to be counted exists, as the specific threshold value for the cartridge used for measurement.

11. The particle counting device according to claim 9, wherein the particle counting device is configured to count the particles in the sample liquid based on each pulse voltage height obtained by the electrical resistance method, and wherein
the computing part is configured
to adjust a standard threshold value of a pulse voltage height of (A) described below, so as to be proportional to a ratio (Vx/Vs) of (a) described below, and
to adopt the adjusted standard threshold value as the specific threshold value for the cartridge:
(A) a standard threshold value of a pulse voltage height, which standard threshold value being predetermined for determining a particle to be counted or a noise particle smaller than the particle to be counted, by using a standard aperture having a predetermined cross-sectional area,
(a) a ratio (Vx/Vs) of a voltage Vx to a standard voltage Vs, wherein
the voltage Vx is a voltage between electrodes when an aperture and a space between the electrodes in a cartridge for measurement are filled with the liquid in a sample liquid, and
the standard voltage Vs is a voltage between electrodes when a standard aperture having a predetermined cross-sectional area and a space between the electrodes are filled with the liquid in a sample liquid.

12. The particle counting device according to claim 9, wherein the particle counting device is configured to count the particles in the sample liquid based on each pulse voltage width obtained by the electrical resistance method, and wherein
the computing part is configured
to adjust a standard threshold value of a pulse voltage width of (B) described below, so as to be inversely proportional to a ratio (Vx/Vs) of (a) described below, and
to adopt the adjusted standard threshold value as the specific threshold value for the cartridge:
(B) a standard threshold value of a pulse voltage width, which standard threshold value being predetermined for determining a particle to be counted or a noise particle smaller than the particle to be counted, by using a standard aperture having a predetermined cross-sectional area,
(a) a ratio (Vx/Vs) of a voltage Vx to a standard voltage Vs, wherein
the voltage Vx is a voltage between electrodes when an aperture and a space between the electrodes in a cartridge for measurement are filled with the liquid in a sample liquid, and
the standard voltage Vs is a voltage between electrodes when a standard aperture having a predetermined cross-sectional area and a space between the electrodes are filled with the liquid in a sample liquid.

13. The particle counting device according to claim 9, wherein the particle counting device is configured to count the particles in the sample liquid based on each pulse voltage height obtained by the electrical resistance method, and wherein
the computing part is configured
to adjust a standard threshold value of a pulse voltage height of (A) described below, so as to be inversely proportional to a ratio (Qx/Qs) of (b) described below, and
to adopt the adjusted standard threshold value as the specific threshold value for the cartridge:
(A) a standard threshold value of a pulse voltage height, which standard threshold value being predetermined for determining a particle to be counted or a noise particle smaller than the particle to be counted, by using a standard aperture having a predetermined cross-sectional area,
(b) a ratio (Qx/Qs) of flow velocity Qx to flow velocity Qs, wherein
the flow velocity Qx is a flow velocity of a sample liquid traveling along a flow channel through an aperture in a cartridge for measurement, and
the flow velocity Qs is a flow velocity of the sample liquid traveling along the flow channel through a standard aperture having a predetermined cross-sectional area.

14. The particle counting device according to claim 9, wherein the particle counting device is configured to count the particles in the sample liquid based on each pulse voltage width obtained by the electrical resistance method, and wherein
the computing part is configured
to adjust a standard threshold value of a pulse voltage width of (B) described below, so as to be proportional to a ratio (Qx/Qs) of (b) described below, and
to adopt the adjusted standard threshold value as the specific threshold value for the cartridge:
(B) a standard threshold value of a pulse voltage width, which standard threshold value being predetermined for determining a particle to be counted or a noise particle smaller than the particle to be counted, by using a standard aperture having a predetermined cross-sectional area.
(b) a ratio (Qx/Qs) of flow velocity Qx to flow velocity Qs, wherein
the flow velocity Qx is a flow velocity of a sample liquid traveling along a flow channel through an aperture in a cartridge for measurement, and
the flow velocity Qs is a flow velocity of the sample liquid traveling along the flow channel through a standard aperture having a predetermined cross-sectional area.
